(19) United States
(12) Patent Application Publication
(10) Pub. No.: US 2012/0101175 A1
(43) Pub. Date: Apr. 26, 2012

(54) Silicone Copolymer Surfactants For Use In Polyurethane Foams

(76) Inventors: Kenneth Lloyd Willoughby, Parkersburg, WV (US); David Davis, Saint Marys, WV (US); Peter Lo, Parkersburg, WV (US)

(21) Appl. No.: 12/672,791

(22) PCT Filed: Aug. 7, 2008
(86) PCT No.: PCT/US08/09461

§ 371 Date: Dec. 22, 2011

Related U.S. Application Data
(60) Provisional application No. 60/964,237, filed on Aug. 10, 2007.

(51) Int. Cl. C08L 75/08; C08K 5/5419; C08L 75/14; C07F 7/18; C08J 9/04

(52) U.S. Cl. 521/86; 556/431; 521/112

(57) ABSTRACT

The present invention provides a novel silicone copolymer surfactant, methods for making the surfactant, a polyurethane foam-forming composition and a process for preparing polyurethane foams.

### BACKGROUND OF THE INVENTION

The present invention relates to novel silicone copolymer surfactant, methods for making the surfactant and a process for preparing polyurethane foams.

In today's current polyurethane technology silicone surfactants are used to assist and control nucleation sites for cell formation, compatibilization of the chemical components and stabilization of cells in the developing polyurethane foam.

One of the many chemical components that must be compatiblized in a polyurethane foam-forming composition is the blowing agent. Typical blowing agents include, e.g., water, fluorocarbons, hydrochlorofluorocarbons, hydrofluorocarbons, hydrocarbons, methyl formate and/or various blends of these, which are used to provide expansion in the foaming process. These blowing agents possess varying levels of solubility or compatibility with the other components used in the formation of polyurethane foams. Developing and maintaining a good emulsification when using components with poor compatibility is critical to processing and achieving acceptable polyurethane foam quality.

Currently silicone surfactants are used to emulsify, nucleate and stabilize the polyurethane foam. This is well known in the literature. The silicone surfactants currently used today for a variety of applications, contain for example, either all ethylene oxide polyether pendants reacted to the siloxane copolymer backbone or all ethylene oxide/propylene oxide pendants.

The present invention provides new silicone surfactants and addresses the problem of incompatibility of polyurethane foam-forming components, with resultant improvements in emulsification and duration of the emulsion of the foam-forming components.

### SUMMARY OF THE INVENTION

The present invention provides a silicone copolymer surfactant comprising the formula:

M*DₓD*_{y}*D**_{z}M*

wherein:

M* is [R¹O(CH(CH₃)CH₂O)ₘ(CH₂CH₂O)ₙR²—]ₐ[CH₃—]₃₋ₐSiO_{1/2}

D is (CH₃)₂SiO_{2/2}

D* is [R³O(CH₂CH₂O)ₒR⁴—][CH₃]SiO_{2/2}

D** is [R⁵O(CH(CH₃)CH₂O)ₚ(CH₂CH₂O)_{q}R⁶—][CH₃—]SiO_{2/2}

each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;

each occurrence of R², R⁴ and R⁶ is a divalent hydrocarbon containing from 1 to 12 carbon atoms;

each occurrence of a, m, n, o, p, q, x, y and z is independently a is 0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen.

The present invention provides a polyurethane-foam forming composition comprising:

a) at least one polyol;

b) at least one polyisocyanate;

c) at least one polyurethane catalyst;

d) at least one blowing agent;

e) an emulsifying amount of at least one silicone copolymer having the formula:

M*DₓD*_{y}*D**_{z}M*

wherein:

M* is [R¹O(CH(CH₃)CH₂O)ₘ(CH₂CH₂O)ₙR²—]ₐ[CH₃—]₃₋ₐSiO_{1/2}

D is (CH₃)₂SiO_{2/2}

D* is [R³O(CH₂CH₂O)ₒR⁴—][CH₃]SiO_{2/2}

D** is [R⁵O(CH(CH₃)CH₂O)ₚ(CH₂CH₂O)_{q}R⁶—][CH₃—]SiO_{2/2}

each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;

each occurrence of R², R⁴ and R⁶ is a divalent hydrocarbon containing from 1 to 12 carbon atoms;

each occurrence of a, m, n, o, p, q, x, y and z is independently a is 0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen;

f) optionally, at least one additional component selected from the group consisting of other polymer and/or copolymer, chain extender, crosslinker, non-aqueous blowing agent, filler, reinforcement, pigment, tint, dye, colorant, flame retardant, antioxidant, antiozonant, UV stabilizer, anti-static agent, biocide and biostat.

Also provided is a process for manufacturing a polyurethane foam comprising the step of reacting at least one polyol with at least one polyisocyanate and emulsifying amount of at least one silicone copolymer surfactant having the general formula:

M*DₓD*_{y}*D**_{z}M*

wherein:

M* is [R¹O(CH(CH₃)CH₂O)ₘ(CH₂CH₂O)ₙR²—]ₐ[CH₃—]₃₋ₐSiO_{1/2}

D is (CH₃)₂SiO_{2/2}

D* is [R³O(CH₂CH₂O)ₒR⁴—][CH₃]SiO_{2/2}

D** is [R⁵O(CH(CH₃)CH₂O)ₚ(CH₂CH₂O)_{q}R⁶—][CH₃—]SiO_{2/2}

each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;

each occurrence of R², R⁴ and R⁶ is a divalent hydrocarbon containing from 1 to 12 carbon atoms;

each occurrence of a, m, n, o, p, q, x, y and z is independently a is 0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen, in the presence of a blowing agent and under conditions sufficient to form the polyurethane foam.

The emulsifying performance of the silicone copolymer surfactants of the present invention provides improved cell stabilization, component emulsification and prolonged processing times for polyurethane foam-forming compositions.

### BRIEF DESCRIPTION OF THE DRAWINGS

FIG. 1 is a graphic representation of the time to achieve a homogeneous emulsion of Comparative Example 3 and 4 and Example 2.

FIG. 2 is a graphic representation of the time to phase separation of Comparative Example 3 and 4 and Example 2.

### DETAILED DESCRIPTION OF THE INVENTION

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range and any combination of the various endpoints of such ranges or subranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

According to one embodiment of the invention, the present invention provides silicone polyether copolymer surfactants possessing enhanced emulsification properties which provide prolonged processing times for polyurethane foam-forming compositions. According to another embodiment, the present invention provides methods for making silicone polyether copolymer surfactants possessing enhanced emulsification properties in polyurethane foam-forming compositions. In still another embodiment of the invention, a polyurethane-foam-forming composition comprising an emulsifying amount of silicone polyether copolymer surfactants is provided.

The silicone polyether copolymer surfactants of the present invention possess a mixture of pendant groups consisting of at least one pendant hydroxyl-terminated polyether group bonded to the silicon atom through a silicon-carbon bond and containing at least one repeat unit derivable from ethylene oxide monomer and at least one pendant hydroxyl-terminated polyether group bonded to the silicon atom through a silicon-carbon bond and containing at least one repeat unit derivable from ethylene oxide and at least one repeat unit derivable from propylene oxide, attached to the same siloxane backbone. The novel surfactants are useful in emulsifying the materials used to manufacture polyurethane foam.

Enhanced emulsification is a desirable effect for the processing of urethane foams, in particular rigid polyurethane foam. The enhanced emulsification provides for prolonged processing times and improved final foam products. Furthermore, improved emulsification can result in the uniform distribution of blowing agents throughout the polyurethane foam, resulting in a fine regular cell structure.

According to an embodiment of the invention, the structure of the silicone copolymer surfactant of the invention is:

M*DₓD*_{y}*D**_{z}M*

wherein:

M* is [R¹O(CH(CH₃)CH₂O)ₘ(CH₂CH₂O)ₙR²—]ₐ[CH₃—]₃₋ₐSiO_{1/2}

D is (CH₃)₂SiO_{2/2}

D* is [R³O(CH₂CH₂O)ₒR⁴—][CH₃]SiO_{2/2}

D** is [R⁵O(CH(CH₃)CH₂O)ₚ(CH₂CH₂O)_{q}R⁶—][CH₃—]SiO_{2/2}

each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;

each occurrence of R², R⁴ and R⁶ is a divalent hydrocarbon containing from 1 to 12 carbon atoms;

each occurrence of a, m, n, o, p, q, x, y and z is independently a is 0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen.

In one embodiment, the each occurrence of R¹, R³ and R⁵ is independently selected from the group consisting of hydrogen, monovalent alkyl, aryl, alkenyl, or aralkyl group of from 1 to 12 carbon atoms. Representative non-limiting examples include hydrogen, methyl, ethyl, propyl, isopropyl butyl, allyl, phenyl, benzyl and the like.

In another embodiment, each occurrence of R², R⁴ and R⁶ is independently a divalent alkylene, arylene, and aralkylene group containing from 1 to 12 carbon atoms. Representative non-limiting examples include methylene, ethylene, propylene, isopropylene, butylene, isobutylene, phenylene, xylylene, and the like.

The polyether chain of M* (when a is 1) and D** can be composed to random distribution of the oxyethylene and oxypropylene repeat units, blocks of oxyethylene and blocks of oxypropylene repeat units or combinations thereof.

In a specific embodiment, each occurrence of R³ and R⁵ is independently hydrogen; each occurrence of R², R⁴ and R⁶ is a divalent alkylene containing 1 to 12 carbon atoms, preferably from 2 to 6 carbon atoms, more preferably from 3 to 4 carbon atoms and most preferably 3 carbon atoms; a is 0 to 1 and preferably 0; o is 1 to 200, preferably 3 to 50, more preferably from 5 to 25 and most preferably from 10 to 15; p is 1 to 200, preferably from 3 to 100, more preferably from 5 to 50 and most preferably from 15 to 35; q is 1 to 200, preferably from 3 to 100, more preferably from 5 to 50 and most preferably from 15 to 35; x is 1 to 100, preferably from 10 to 85, more preferably from 25 to 75 and most preferably from 50 to 70; y is 1 to 50, preferably 1 to 25, more preferably 1 to 10 and most preferably 2 to 4; and z is 1 to 50, preferably 1 to 25, more preferably 1 to 10 and most preferably 2 to 4.

In another specific embodiment, each occurrence of R³ and R⁵ is independently hydrogen; each occurrence of R², R⁴ and R⁶ is a divalent alkylene containing 3 to 4 carbon atoms; a is 0; o is 10 to 15; p is 15 to 35; q is from 15 to 35; x is 25 to 75; y is 1 to 10; and z is 1 to 10.

In still another embodiment, each occurrence of R³ and R⁵ is independently hydrogen; each occurrence of R², R⁴ and R⁶ is a propylene; a is 0, o is 10 to 15; p is 15 to 35; q is 15 to 35; x is 50 to 75; y is 1 to 10 and z is 1 to 10.

In yet another embodiment, each occurrence of R³ and R⁵ is independently hydrogen and the molar ratio of y/z is from 1/10 to 10/1; more preferably from 1/5 to 5/1; and most preferably from 1/2 to 2/1.

Accordingly, the silicone copolymer surfactants of the present invention can be prepared by several synthetic approaches including staged addition of the polyethers. Moreover, the polyoxyalkylene polyether components are well known in the art and/or can be produced by any conventional process. For instance, hydroxy terminated polyoxyalkylene polyethers which are convenient starting materials in the preparation of the terpolymer can be prepared by reacting a suitable alcohol with ethylene oxide and propylene oxide (1,2-propylene oxide) to produce the copolymer, or with ethylene oxide alone to produce the polyoxyethylene ether. Suitable alcohols are, e.g. methanol, ethanol, propanol, isopropanol, butanol, tertiary butanol, and the like; and hydroxy alkenyl compounds, e.g., allyl alcohol, methallyl alcohol and the like. In general the alcohol starter preferably is placed in an autoclave or other high-pressure vessel along with catalytic amounts of a suitable catalyst, such as sodium hydroxide, potassium hydroxide, other alkali metal hydroxides, or sodium or other alkali metals. Further details of preparation are set forth in, for example, U.S. Pat. No. 3,980,688. The entire contents of which are herein incorporated by reference.

The above-described alcohol-oxide reaction produces a monohydroxy end-blocked polyoxyalkylene polyether in which the other end-blocking group is an alkoxy, aryloxy, or alkenyloxy radical. These polyethers may be converted to monoalkenyloxy-terminated polyoxyalkylene polyethers by capping the hydroxy terminal group of said monohydroxy end-blocked poly(oxyethyleneoxypropylene) copolymers and/or poly(oxyethylene) copolymers by any conventional means.

The method of producing the novel polysiloxane-polyoxyalkylene block terpolymers of this invention can be conducted in the same manner as any conventional known method for producing polysiloxane polyoxyalkylene block copolymers such as described, e.g. in U.S. Pat. Nos. 2,834,748, 2,920,1150 and 3,801,616, the entire contents of which are herein incorporated by reference. Such conventional methods have been described above. Production of these compositions involve the common chemical reactions of reacting, for instance, a polyoxyalkylene polyether with a polysiloxane containing silanic hydrogen at elevated temperatures, e.g., from about 60° C. to about 140° C. in the presence of a catalyst such as platinum catalysts (e.g., chloroplatinic acid), and the like and optionally in the presence of a solvent (e.g., liquid hydrocarbons, such as isopropyl alcohol and the like) for the polyoxyalkylene polyether and polysiloxane reactants. The usual conventional amounts of components and reaction conditions can be employed and such is well within the knowledge of one skilled in the art. For instance, approximately stoichiometric amounts of slightly higher polyalklylene polyethers and the functional polysiloxane reactants are preferred, while the amount of the catalyst need obviously only is a catalytic amount. The temperatures of the reaction, of course, depend largely on the reactants involved and the desired polysiloxane-polyoxyalkylene block terpolymer.

Of course, it is to be understood that the polysiloxane-polyoxyalkylene block copolymers of this invention can contain small amounts of other siloxy units, e.g. SiH groups (owing to incomplete reaction thereof with the polyoxyalkylene reactant and/or Si-alkoxy or Si—OH groups owing to incomplete hydrolysis and condensation of the silanes used to produce the siloxane reactant, as disclosed in U.S. Pat. No. 4,814,409 the contents of which are incorporated herein by reference.

According to one specific embodiment, the silicone copolymer surfactant of the invention is obtained by reacting at least one poly(oxyethyleneoxypropylene) polyether and at least one poly(oxyethylene) polyether each of the polyethers possessing a single terminal olefinic group with a hydrosiloxane possessing two terminal SiH groups and no SiH group in the backbone thereof under hydrosilation reaction conditions, the ratio of olefinic groups to SiH groups ranging from 1.0 to 1.3, and preferably from 1.0 to 1.1, and optionally, end-capping a terminal hydroxyl group of the resulting terminally ethylenically unsaturated polyether.

According to another specific embodiment, the silicone copolymer surfactant of the invention is obtained by reacting at least one poly(oxyethyleneoxypropylene) polyether and at least one poly(oxyethylene) polyether each of the polyethers possessing a single terminal olefinic group and a single hydroxyl group with a hydrosiloxane possessing at least two pendent SiH groups under hydrosilation reaction conditions, the ratio of olefinic groups to SiH groups ranging from 1.0 to 1.3, and preferably from 1.0 to 1.1, and optionally, end-capping a terminal hydroxyl group of the resulting terminally ethylenically unsaturated polyether.

According to an embodiment of the invention a polyurethane-foam forming composition is provides which comprises:

a) at least one polyol;

b) at least one polyisocyanate;

c) at least one polyurethane catalyst;

d) at least one blowing agent;

e) an emulsifying amount of at least one silicone copolymer having the formula:

M*DₓD*_{y}*D**_{z}M*

wherein:

M* is [R¹O(CH(CH₃)CH₂O)ₘ(CH₂CH₂O)ₙR²—]ₐ[CH₃—]₃₋ₐSiO_{1/2}

D is (CH₃)₂SiO_{2/2}

D* is [R³O(CH₂CH₂O)ₒR⁴—][CH₃]SiO_{2/2}

D** is [R⁵O(CH(CH₃)CH₂O)ₚ(CH₂CH₂O)_{q}R⁶—][CH₃—]SiO_{2/2}

each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;

each occurrence of R², R⁴ and R⁶ is a divalent hydrocarbon containing from 1 to 12 carbon atoms;

each occurrence of a, m, n, o, p, q, x, y and z is independently a is 0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen.

According to an embodiment of the invention, the polyurethane-foam forming composition optionally comprises, at least one additional component, component (f), selected from the group consisting of other polymer and/or copolymer, chain extender, crosslinker, non-aqueous blowing agent, filler, reinforcement, pigment, tint, dye, colorant, flame retardant, antioxidant, antiozonant, UV stabilizer, anti-static agent, biocide and biostat.

Among the suitable polyols (a) for preparing the polyurethane foam of the present invention are those having 2 to 8 hydroxyl groups per molecule and a weight average molecular weight of from 100 to 2000, preferably a weight average molecular weight of from 400 to 1200. Included among the useful polyols are polyether diols and triols, polyester diols and triols and hydroxyl-terminated polyolefin polyols such as the polybutadiene diols. Other useful polyols include copolymers of polymeric materials grafted onto the main polyol chain such as, for example, SAN (styrene/acrylonitrile) or AN (acrylonitrile) grafted onto polyether polyols, commonly referred to as copolymer polyols, polyols derived from naturally occurring materials such as castor oil, chemically-modified soybean oil or other chemically-modified fatty acid oils and polyols resulting from the alkoxylation of such naturally occurring materials as castor oil and soybean.

Preferred polyols (a) are the polyether diols and triols, particularly those derived from one or more alkylene oxides, phenyl-substituted alkylene oxides, phenyl-substituted alkylene oxides and/or ring-opening cyclic ethers such as ethylene oxide, propylene oxide, styrene oxide, tetrahydrofuran, and the like, advantageously having a weight average molecular weight of from 100 to 2000 and preferably a weight average molecular weight from 400 to 1200. Examples of such polyether diols include, for example, Pluracol P410R (Pluracol is a registered trademark of BASF).

Suitable polyisocyanates (b) include, for example, methylenediphenylenediisocyanate (MDI) including 4,4′ and 2,4′ isomers and polymeric forms of MDI often referred to as polymeric MDI. Isocyanate prepolymers of MDI made from the reaction of MDI with polyols; modified versions of such as uretonimine-modified MDI; and combinations in any proportions of MDI variants named above. Suitable toluenediisocyanate (TDI), including 2,4 and 2,6 isomers and isocyanate prepolymers of TDI made from the reaction of TDI with polyols, or other aromatic or aliphatic isocyanates and modified versions including uretonimine-modification and prepolymers of these isocyanates can be used in the invention.

Catalyst(s) (c) include alkali metal carboxylates such as potassium octoate, potassium acetate, sodium acetate and sodium octoate, heavy metal-based catalysts such as those of mercury or lead, tertiary amine urethane catalysts such as N,N,N′,N″, N″-pentamethyldiethylenetriamine, e.g. Niax C-5 and quaternary ammonium salt catalysts such as quaternary ammonium carboxylate. Other useful urethane catalysts (c) include foam-forming organometallic catalysts such as nickelacetoacetonate, ironacetoacetonate, tin-based catalysts bismuth-based catalysts and zinc-based catalysts.

One or more blowing agents (d), either of the physical and/or chemical type, can be included in the reaction mixture. Typical physical blowing agents include, e.g., fluorocarbons, hydrochlorofluorocarbons, hydrofluorocarbons, hydrocarbons, methyl formate and/or various blends of these, which are used to provide expansion in the foaming process. A typical chemical blowing agent is water, which reacts with isocyanates in the foam, forming reaction mixture to produce carbon dioxide gas. These blowing agents possess varying levels of solubility or compatibility with the other components used in the formation of polyurethane foams. Developing and maintaining a good emulsification when using components with poor compatibility is critical to processing and achieving acceptable polyurethane foam quality.

The siloxane-polyoxyalkylene copolymer surfactant of the present invention comprises at least one ethylene oxide pendant and at least one ethylene oxide/propylene oxide pendant group and those possessing hydroxy functionality (i.e., uncapped) are incorporated into the polyurethane foam system. Accordingly, the siloxane copolymer surfactants that are “capped,” for example, with methoxy or acetoxy groups, do not react into the polyurethane system.

According to one embodiment, the total amount of surfactant is between 0.1 weight percent and 2.0 weight percent of the total polyurethane formulation. According to another embodiment, the total amount of surfactant is between 0.5 weight percent and 1.5 weight percent of the total polyurethane formulation. According to yet another embodiment, the total amount of surfactant is between 0.75 weight percent and 1.25 weight percent of the total polyurethane formulation. The polyurethane polymer system of the invention also comprises a polyol component, an isocyanate component, a blowing agent, polyurethane catalyst and other typical polyurethane foam additives.

The amounts of polyol(s) (a), polyisocyanate(s) (b), catalyst(s) (c), blowing agent(s) (d) and silicone copolymer surfactant(s) (e) employed in the polyurethane foam-forming reaction medium herein can vary over fairly wide limits, e.g., as set forth in the following table:

| Component of the Polyurethane | | |
|---|---|---|
| Foam-forming Reaction Medium | Broad Range | Preferred Range |
| Polyol(s) (a), e.g., polyether diols, | 100 | 100 |
| triols, etc. | | |
| Polyisocyanate(s)(b), e.g., | 30-400 | 40-350 |
| diisocyanate | | |
| Catalyst(s) (c), e.g., tertiary amines, | 0.01-5 | 0.02-2 |
| tins, etc | | |
| Blowing agent(s) (d) | 0.01-10 | 0-8 |
| Silicone copolymer surfactant(s) (e) | 0.1-10 | 0.5-5 |

Ranges in pphp (parts per 100 parts polyol by weight

Optional components(s) (f) include any of those known in the art in known amounts and include other polyhydroxyl-terminated materials such as those having 2 to 8 hydroxyl groups per molecule and a molecular weight from 62 to 500 that function as crosslinkers or chain extenders. Examples of useful chain extenders having two hydroxyl groups include dipropylene glycol, diethylene glycol, 1,4-butanediol, ethylene glycol, 2,3-butanediol and neopentylglycol. Crosslinkers having 3 to 8 hydroxyl groups include glycerine, pentaerythritol, mannitol, and the like.

Other optional (f) component(s) are known in the art and include fillers, e.g., inorganic fillers or combinations of fillers. Fillers may include those for density modification, physical property improvements such as mechanical properties or sound absorption, fire retardancy or other benefits including those that may involve improved economics such as, for example, calcium carbonate or other fillers that reduce the cost of manufactured foam, aluminum trihydrate or other fire retardant fillers, barium sulfate or other high-density filler that is used for sound absorption, microspheres of materials such as glass or polymers that may also further reduce foam density. Fillers of high aspect ratio that are used to modify mechanical properties such as foam stiffness or flexural modulus that would include: man-made fibers such as milled glass fiber or graphite fiber; natural mineral fibers such as wollastonite; natural animal such as wool or plant fibers such as cotton; man-made plate-like fillers such as shattered glass; natural mineral plate-like fillers such as mica; possible addition of any pigments, tints or colorants. Additionally, the invention contemplates the use of organic flame retardants; antiozonants, antioxidants; thermal or thermal-oxidative degradation inhibitors, UV stabilizers, UV absorbers or any other additive(s) that when added to the foam-forming composition will prevent or inhibit thermal, light, and/or chemical degradation of the resulting foam. Also contemplated for use herein are any of the known and conventional biostatic agents, antimicrobial agents and gas-fade inhibiting agents.

### EXAMPLES

### Example 1

### Preparation of Silicone Surfactant

Into a 500 mL round bottom flask equipped with a mechanical stirrer and dry nitrogen line, were charged allyl-terminated polyethylene glycol (58.5 grams, 0.117 mole of APEG 550 from Dow Chemical), allyl-terminated poly(oxyethyleneoxypropylene)glycol (117.8 grams, 0.030 mole of 40HA2700 from Dow Chemical) and tributyl amine (0.05 gram, 0.0005 mole). The mixture was stirred. The Si—H fluid, (CH₃)₃SiO[(CH₃)₂SiO]₆₅[CH₃SiHO]₇Si(CH₃)₃, (73.7 grams, 0.014 mole) was added and the mixture heated to 85° C. with stirring. The catalyst, chloroplatinic acid, (3.3% chloroplatinic acid in isopropanol, 0.36 mL) was added and the mixture heated to a maximum temperature of 103° C. and heated for 35 minutes. The mixture was cooled to room temperature to yield 250 grams of silicone surfactant.

### Example 2 and Comparative Examples 3 and 4

Polyurethane foam-forming compositions were prepared with the formulation presented in Table 1. The polyurethane foam-forming compositions were prepared with the following silicone surfactants: Example 2 which contained a silicone copolymer surfactant having both ethylene oxide (EO) and ethylene oxide/propylene oxide (EO/PO) pendant groups prepared in Example 1; Comparative Example 3 which contained a silicone copolymer surfactant having EO/PO pendant groups only; and Comparative Example 4 which contained a silicone copolymer surfactant having propylene oxide (PO) pendant groups only. The polyurethane foam-forming composition contained typical use levels of silicone. The Example and Comparative Examples were used to determine the effect of the silicone surfactant copolymer on emulsion quality and duration.

TABLE 1

| Material | pphp |
|---|---|
| *Terate ® 3512 | 100.00 |
| Water | 1.00 |
| Flame Retardant | 10.00 |
| Potassium Octoate | 2.25 |
| Potassium Acetate | 1.00 |
| **Niax ® C-5 | 0.37 |
| Silicone | 2.50 |
| N-pentane | 21.00 |
| MDI | 225.00 |
| Index | 250 |

*Terate ® is a trademark of INVISTA S.à.r.l.
**Niax ® is a trademark of Momentive Performance Materials.

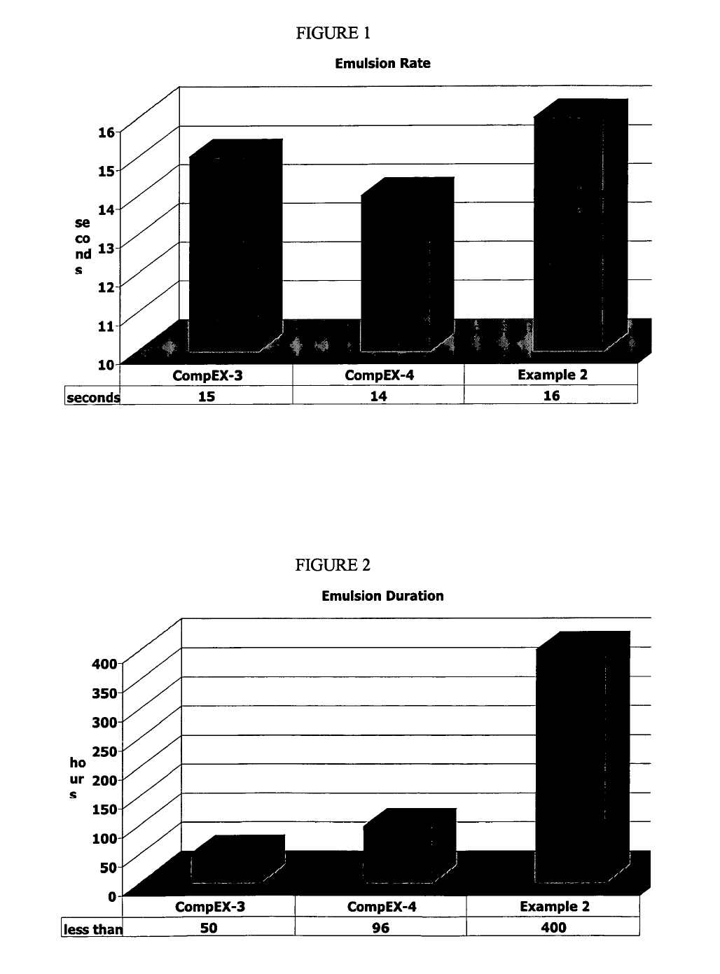

To gauge the emulsification effect of the surfactant prepared in Example 1 and the surfactant used in Comparative Examples 3 and 4, the ingredients listed in Table 1, excluding the MDI were placed in a container and blended at 1500 rpms. The time necessary to achieve a homogeneous emulsion, judged as a uniform appearance, was recorded and is displayed in FIG. 1. The time varied from 14 to 16 seconds and was not significantly different between repeated trials or between Example 2 and Comparative Examples 3 and 4. The emulsions were then placed into clear bottles and observed for separation. Separation is defined as the time interval for the first observation of any phase separation of the components, which was recorded and is presented in FIG. 2. As indicated by the data in FIG. 2, the emulsion duration of Example 2 is significantly longer than that of Comparative Examples 3 and 4.

Evaluation of the physical properties of polyurethane foam prepared from the polyurethane foam-forming formulation of Table 1 containing the silicone copolymer surfactants used in Comparative Example 2 and prepared in Example 1 was conducted by preparing foam samples in a 15″×15″×4″ mold using the surfactants of the examples at the same use level. The result are presented in Table 2.

TABLE 2

| | Comparative | |
|---|---|---|
| | Example 1 | Example 1 |
| Density (lbs./ft³) | | |
| Total | 2.05 | 2.05 |
| Core | 2.0 | 2.0 |
| k-Factor (BTU · In/hr · ft² · ° F. | 0.165 | 0.170 |
| @ 75° F. mean) | | |
| Compressive Strength (psi) | | |
| Parallel | 27 | 30 |
| Perpendicular | 18 | 23 |

The data presented in Table 2 indicates that Example 2, which contained silicone copolymer surfactant containing both EO and EO/PO pendant groups, had increased duration of the polyurethane foam-forming composition (i.e., emulsion) without affecting the physical properties of the foam. This is extremely valuable to the manufacturer of polyurethane foam in that it allows for improved processability and extended master-batch shelf life.

While the invention has been described with reference to a preferred embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims. All citations referred herein are expressly incorporated herein by reference.

1. A silicone copolymer surfactant comprising the formula:
M*DₓD*_{y}*D**_{z}M*
wherein:
M* is [R¹O(CH(CH₃)CH₂O)ₘ(CH₂CH₂O)ₙR²—]ₐ[CH₃—]₃₋ₐSiO_{1/2}
D is (CH₃)₂SiO_{2/2}
D* is [R³O(CH₂CH₂O)ₒR⁴—][CH₃]SiO_{2/2}
D** is [R⁵O(CH(CH₃)CH₂O)ₚ(CH₂CH₂O)_{q}R⁶—][CH₃—]SiO_{2/2}
each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;
each occurrence of R², R⁴ and R⁶ is a divalent hydrocarbon containing from 1 to 12 carbon atoms;
each occurrence of a, m, n, o, p, q, x, y and z is independently a ═0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen.

2. The silicone copolymer surfactant of claim 1, wherein each occurrence of R³ and R⁵ is independently hydrogen; each occurrence of R², R⁴ and R⁶ is a divalent alkylene containing from 2 to 6 carbon atoms; a is 0; o is 5 to 25; p is 5 to 50; q is 5 to 50; x is preferably from 10 to 85; y is 1 to 10; and z is 1 to 10.

3. The process for providing a silicone copolymer surfactant of claim 1, wherein the silicone copolymer surfactant is obtained by reacting at least one poly(oxyethyleneoxypropylene) polyether and at least one poly(oxyethylene) polyether each of the polyethers possessing a single terminal olefinic group and a single hydroxyl group with a hydrosiloxane possessing at least two pendent SiH groups under hydrosilation reaction conditions, the ratio of olefinic groups to SiH groups ranging from 1.0 to 1.3.

4. A polyurethane-foam forming composition comprising:
a) at least one polyol;
b) at least one polyisocyanate;
c) at least one polyurethane catalyst;
d) at least one blowing agent;
e) an emulsifying amount of at least one silicone copolymer surfactant comprising the formula:
M*DₓD*_{y}*D**_{z}M*
wherein:
M* is [R¹O(CH(CH₃)CH₂O)ₘ(CH₂CH₂O)ₙR²—]ₐ[CH₃—]₃₋ₐSiO_{1/2}
D is (CH₃)₂SiO_{2/2}
D* is [R³O(CH₂CH₂O)ₒR⁴—][CH₃]SiO_{2/2}
D** is [R⁵O(CH(CH₃)CH₂O)ₚ(CH₂CH₂O)_{q}R⁶—][CH₃—]SiO_{2/2}
each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;
each occurrence of R², R⁴ and R⁶ is a divalent hydrocarbon containing from 1 to 12 carbon atoms;
each occurrence of a, m, n, o, p, q, x, y and z is independently a ═0 to 1; m is 0 to 200; n is 0 to 200; o is 1 to 200; p is 1 to 200; q is 1 to 200; x is 1 to 100; y is 1 to 50 and Z is 1 to 50, with the proviso that at least one R³ and at least one R⁵ is hydrogen; and
f) optionally, at least one additional component selected from the group consisting of other polymer and/or copolymer, chain extender, crosslinker, non-aqueous blowing agent, filler, reinforcement, pigment, tint, dye, colorant, flame retardant, antioxidant, antiozonant, UV stabilizer, anti-static agent, biocide and biostat.

5. The composition of claim 4 wherein the polyol (a) is at least one selected from the group consisting of polyether polyol, polyester polyol, polycaprolactone polyol, polycarbonate polyol, polybutadiene polyol, hydroxyl-terminated polyolefin polyols, graphed polyol and polyols derived from a natural source.

6. The composition of claim 5 wherein the grafted polyol component (a) is at least one selected from the group consisting of styrene/acrylonitrile (SAN) graphed polyether polyol, acrylonitrile (AN)-graphed polyether polyol and graphed polyester polyols.

7. The composition of claim 5 wherein the polyol component (a) is at least one selected from the group consisting of polyether-terminated polybutadiene and polyether-terminated polyols derived from a natural source.

8. The composition of claim 4 wherein the polyisocyanate (b) is at least one selected from the group consisting of methanediphenyl diisocyanate (MDI), polymeric MDI, modified MDI, prepolymers of MDI, toluenediisocyanate (TDI), prepolymers of TDI and modified TDI.

9. The composition of claim 8 wherein polyisocyanate (b) is at least one selected from the group consisting of 4,4′ methanediphenyl diisocyanate, 2,4′ methanediphenyl diisocyanate, 2,2′ methanediphenyl diisocyanate, 2,4-toluenediisocyanate, and 2,6-toluene diisocyanate.

10. The composition of claim 4 wherein the catalyst is at least one selected from the group consisting of organometallic catalysts, alkali metal carboxylates catalysts, heavy metal-based catalysts and tertiary amine urethane catalysts.

11. The composition of claim 10 wherein the catalyst is at least one selected from the group consisting of nickelacetoacetonate, ironacetoacetonate, tin-based catalysts, bismuth-based catalysts, zinc-based catalysts, potassium octoate, potassium acetate, sodium acetate, sodium octoate, mercury, lead, triethylene diamine and quaternary ammonium carboxylate.

12. The composition of claim 4 wherein the polyurethane foam-forming composition comprises from 10 to 85 weight percent polyol (a), from 20 to 80 weight percent polyisocyanate (b), from 0.1 to 5.0 weight percent catalyst (c), from 0.1 to 15.0 weight percent blowing agent (d) and from 0.1 to 2.0 weight percent silicone copolymer surfactant (e).

13. The composition of claim 4 wherein the polyurethane foam-forming composition comprises from 30 to 75 weight percent polyol (a), from 30 to 75 weight percent polyisocyanate (b), from 0.5 to 4.0 weight percent catalyst (c), from 0.5 to 13.0 weight percent blowing agent (d) and from 0.5 to 1.5 weight percent silicone copolymer surfactant (e).

14. The composition of claim 4 wherein the polyurethane foam-forming composition comprises from 35 to 65 weight percent polyol (a), from 35 to 70 weight percent polyisocyanate (b), from 0.8 to 3.5 weight percent catalyst (c), from 0.5 to 12.0 weight percent blowing agent (d) and from 0.75 to 1.25 weight percent silicone copolymer surfactant (e).

15. A polyurethane foam prepared from the composition of claim 4.

16. A process for manufacturing a polyurethane foam comprising the step of reacting at least one polyol with at least one polyisocyanate and emulsifying amount of at least one silicone copolymer surfactant having the general formula:
M*DₓD*_{y}*D**_{z}M*
wherein:
M* is [R¹O(CH(CH₃)CH₂O)ₘ(CH₂CH₂O)ₙR²—]ₐ[CH₃—]₃₋ₐSiO_{1/2}
D is (CH₃)₂SiO_{2/2}
D* is [R³O(CH₂CH₂O)ₒR⁴—][CH₃]SiO_{2/2}
D** is [R⁵O(CH(CH₃)CH₂O)ₚ(CH₂CH₂O)_{q}R⁶—][CH₃—]SiO_{2/2}
each occurrence of R¹, R³ and R⁵ is independently selected from the group consisting of hydrogen, monovalent hydrocarbon group of from 1 to 12 carbon atoms, R⁷₃Si— and R⁷(C═O)— group wherein R⁷ is a monovalent hydrocarbon from 1 to 18 carbon atoms;
each occurrence of R², R⁴ and R⁶ is a divalent hydrocarbon containing from 1 to 12 carbon atoms;
each occurrence of a, m, n, o, p, q, x, y and z is independently a ═0 to 1; m is 0 to 200; n is 0 to 200; o is 1 to 200; p is 1 to 200; q is 1 to 200; x is 1 to 100; y is 1 to 50 and z is 1 to 50, with the proviso that at least one R³ and at least one R⁵ is hydrogen, in the presence of a blowing agent and under conditions sufficient to form the polyurethane foam.

17. The process of claim 16 wherein the polyurethane foam-forming composition comprises from 10 to 85 weight percent polyol (a), from 20 to 80 weight percent polyisocyanate (b), from 0.1 to 5.0 weight percent catalyst (c), from 0.1 to 15.0 weight percent blowing agent/water (d) and from 0.1 to 2.0 weight percent silicone copolymer surfactant (e).

18. The process of claim 16 wherein the polyurethane foam-forming composition comprises from 30 to 75 weight percent polyol (a), from 30 to 75 weight percent polyisocyanate (b), from 0.5 to 4.0 weight percent catalyst (c), from 0.5 to 13.0 weight percent blowing agent/water (d) and from 0.5 to 1.5 weight percent silicone copolymer surfactant (e).

19. The process of claim 16 wherein the polyurethane foam-forming composition comprises from 35 to 65 weight percent polyol (a), from 35 to 70 weight percent polyisocyanate (b), from 0.8 to 3.5 weight percent catalyst (c), from 0.5 to 12.0 weight percent blowing agent/water (d) and from 0.75 to 1.25 weight percent silicone copolymer surfactant (e).

20. The process of claim 16 wherein the silicone copolymer surfactant is obtained by reacting at least one poly(oxyethyleneoxypropylene) polyether and at least one poly(oxyethylene) polyether each of the polyethers possessing a single terminal olefinic group with a hydrosiloxane possessing two terminal ≡SiH groups and no ≡SiH group in the backbone thereof under hydrosilation reaction conditions, the ratio of olefinic groups to ≡SiH groups ranging from 1.0 to 1.1, and optionally, end-capping a terminal hydroxyl group of the resulting terminally ethylenically unsaturated polyether.

21. A polyurethane foam prepared from the process of claim 16.

22. A polyurethane foam prepared with the silicone copolymer surfactant of claim 1.
